(19) United States
(12) Patent Application Publication
(10) Pub. No.: US 2026/0348543 A1
(43) Pub. Date: Nov. 5, 2026

(54) Suspension Unit for Light-Emitting Device, and Suspension Structure for Light-Emitting Device

(71) Applicant: TEAMLAB INC., Chiyoda-ku, Tokyo (JP)

(72) Inventor: Shigeru KAWAI, Chiyoda-ku, Tokyo (JP)

(73) Assignee: TEAMLAB INC., Chiyoda-ku, Tokyo (JP)

(21) Appl. No.: 19/486,012

(22) PCT Filed: Nov. 7, 2024
(86) PCT No.: PCT/JP2024/039553

§ 371 Date: Nov. 19, 2025

(30) Foreign Application Priority Data
Jan. 15, 2024 (JP) 2024-003680

(51) Int. Cl. F21S 8/06; F21S 4/20; F21V 33/00; F21W 121/00; F21Y 103/10; F21Y 115/10

(52) U.S. Cl. CPC F21S 8/063; F21S 4/20; F21V 33/0064; F21W 2121/00; F21Y 2103/10; F21Y 2115/10

(57) ABSTRACT

To enable installation of a light-emitting device below a sprinkler head while complying with the installation standards of the head. A suspension unit (30) is for suspending a light-emitting device (20) from a ceiling (10) and comprises: a plurality of hanging columns (31) fixed to the ceiling; and a support part (32) for supporting the light-emitting device (20) provided at a lower part of the plurality of hanging columns (31). The suspension unit (30) is configured so that all of the plurality of hanging columns (31) are outside an open range H in the horizontal direction centered on a sprinkler head SP and determined by the installation standards of the head, and the support part (32) is provided at the lower part of the hanging columns (31) so that the support part is outside an open range (height V) in the vertical direction from the head determined by the installation standards.

### TECHNICAL FIELD

The present invention relates to a suspension unit for suspending a light-emitting device from a ceiling, and the like.

### BACKGROUND ART

The present applicant previously developed a light-emitting device in which a plurality of light-emitting elements, such as LEDs, are coupled up and down, and provided an artistic work in which the multiple light-emitting devices are suspended from a ceiling (NPL1). In this artistic work, a collection of light points is used to create three-dimensional objects, and since spectators can enter the work, this artistic work has been well-received as a highly immersive work. Especially, the ceiling surface, the floor surface, and the wall surfaces of the interior space in which the multiple light-emitting devices are suspended are each covered with mirrors, and this can give the spectators an impression as if the light emitted from the light-emitting devices spreads infinitely.

### Citation List

### Non Patent Literature

NPL 1: teamLab, “The Infinite Crystal Universe”, [online], 2018, [searched on Jan. 5, 2024], Internet <URL: https://www.teamlab.art/jp/w/infinite_crystaluniverse/>

### SUMMARY OF INVENTION

### Technical Problem

Incidentally, it is obliged to install sprinklers in a room with a certain floor area. Since the above-described work of the present applicant is assumed to be exhibited in a room with a relatively large floor area, it is necessary to install a sprinkler head (sprinkler system) at at least one or more positions on the ceiling in the room. While the installation standards for the sprinkler heads vary depending on factors such as the type and scale of the facility, their use, the building height, and the room's floor level, as well as by country and region, as a general rule to prevent obstruction of water discharge from the heads, the installation of any other object is prohibited within a predetermined horizontal radius centered on the head and within a predetermined vertical height from the head. For example, in a columnar range within a radius of 30 cm in the horizontal direction from the head and within 45 cm in the vertical direction from the head, an object, such as a lighting fixture and a partition, is not allowed to be placed. In this application, such a range in which an object is not allowed to be placed around a sprinkler head is referred to as a “clearance zone.”

Since the installation standards of the sprinkler head must be complied with, when the above-described work was exhibited, the light-emitting devices were not allowed to be suspended from the ceiling around the sprinkler head. Therefore, the present applicant had not installed the light-emitting device around or below the sprinkler head, and for example, a path for the spectators was made there. However, to expand the range of expression of the work and further enhance the immersiveness of the work by reducing the restriction on the exhibition of the work, it is desired to suspend the light-emitting device also below the sprinkler head.

Therefore, it is a main object of the present invention to make installation of a light-emitting device possible also below a sprinkler head while complying with installation standards of the sprinkler head to enhance a degree of freedom of the installation of the light-emitting device.

### Solution to Problem

The inventor of the present invention seriously examined means to solve the above-described problem and developed a suspension unit having a structure capable of avoiding a clearance zone around a sprinkler head. By installing this suspension unit around the sprinkler head and then suspending a light-emitting device from the suspension unit, the light-emitting device can be installed also below the head while complying with installation standards of the sprinkler head. Then, the inventor has come up with the idea that the above-described problem can now also be solved based on this finding, thus completing the present invention. Specifically, the present invention has the following configuration.

A first aspect of the present invention relates to a suspension unit 30 for suspending a light-emitting device 20 from a ceiling 10. The light-emitting device 20 suspended by the suspension unit 30 is not limited to one including a plurality of light-emitting elements (LED or the like) connected up and down as described above but may be a general lighting fixture, such as a pendant light and a spotlight. The suspension unit 30 according to the present invention includes a plurality of hanging columns 31 and a support part 32. The hanging columns 31 are each fixed to the ceiling 10. The support part 32 is provided at lower portions of the plurality of hanging columns 31, and the light-emitting device 20 is supported by this support part 32. Here, the suspension unit 30 according to the present invention is configured such that all of the plurality of hanging columns 31 can be arranged outside a clearance zone (radius H) having a sprinkler head SP as a center in a horizontal direction specified in installation standards of the sprinkler head. In the suspension unit 30 according to the present invention, the support part 32 is provided at the lower portions of the hanging columns 31 so as to be outside the clearance zone (height V) from the head SP in a vertical direction specified in the installation standards. Therefore, by installing this suspension unit 30 around the sprinkler head SP, the clearance zone around the head SP can be secured by the suspension unit 30. Especially, even immediately below the sprinkler head SP, the light-emitting device 20 can be suspended as long as the light-emitting device 20 is spaced from the head SP by the height V. Thus, by using the suspension unit 30 of the present invention, even immediately below the sprinkler head SP, the light-emitting device 20 can be installed while complying with the installation standards of the head SP.

In the suspension unit 30 according to the present invention, the hanging columns 31 are preferably each formed in a cylindrical shape with a through-hole 31a through which one or a plurality of cables 23 connected to the light-emitting device 20 are allowed to be inserted. Thus, by forming the hanging column 31 of the suspension unit 30 in a cylindrical shape, the cable 23 extending from the light-emitting device 20 can be covered up, and the cable 23 can be guided up into the space above the ceiling.

In the suspension unit 30 according to the present invention, a hanging bolt 31b is preferably further inserted through the through-hole 31a of the hanging column 31, and the hanging column 31 is preferably fixed to the ceiling 10 using the hanging bolt 31b. Thus, by using this hanging bolt 31b, the suspension unit 30 can be stably fixed to the ceiling 10.

In the suspension unit 30 according to the present invention, the support part 32 preferably includes a frame body 32a and a plurality of cross members 32b. The frame body 32a is fixed to the hanging column 31. The cross members 32b are fixed to the frame body 32a at intervals from each other. The light-emitting device 20 is preferably supported by the cross members 32b of the support part 32. Thus, by fixing the plurality of cross members 32b to the frame body 32a at intervals, even when a fire breaks out in the room and water needs to be sprinkled from the sprinkler head SP, since water passes through the spaces between the cross members 32b, the suspension unit 30 does not hinder sprinkling water.

A second aspect of the present invention relates to a suspension structure 100 for suspending the light-emitting device 20 from the ceiling 10. The suspension structure 100 according to the present invention includes a ceiling surface 11, a supporting structure body 13 provided on a back side of the ceiling surface 11, a sprinkler head SP provided on a front side of the ceiling surface 11, and a suspension unit 30 for suspending the light-emitting device 20 below the sprinkler head SP. The suspension unit 30 includes a plurality of hanging columns 31 fixed to the supporting structure body 13, and a support part 32 provided at a lower portion of the plurality of hanging columns 31 to support the light-emitting device 20. The suspension unit 30 is configured such that all of the plurality of hanging columns 31 are outside a clearance zone (radius H) having a sprinkler head SP as a center in a horizontal direction specified in installation standards of the sprinkler head SP, and the support part 32 is provided at the lower portion of the hanging columns 31 so as to be outside the clearance zone (height V) from the head SP in a vertical direction specified in the installation standards.

### Advantageous Effects of Invention

Since the present invention enables the installation of the light-emitting device also below the sprinkler head while complying with the installation standards of the sprinkler head, a degree of freedom of the installation of the light-emitting device can be enhanced.

### BRIEF DESCRIPTION OF DRAWINGS

FIG. 1 is a schematic diagram illustrating a suspension structure for a light-emitting device from a side surface direction.

FIG. 2 is a perspective view mainly illustrating a configuration of the suspension unit.

FIG. 3 is a perspective view mainly illustrating an internal configuration of a hanging column of the suspension unit.

### DESCRIPTION OF EMBODIMENTS

An embodiment of the present invention will be described below with reference to the drawings. The present invention is not limited to the embodiment described below, and includes any modifications of the following embodiment as appropriate in the scope obvious to those skilled in the art.

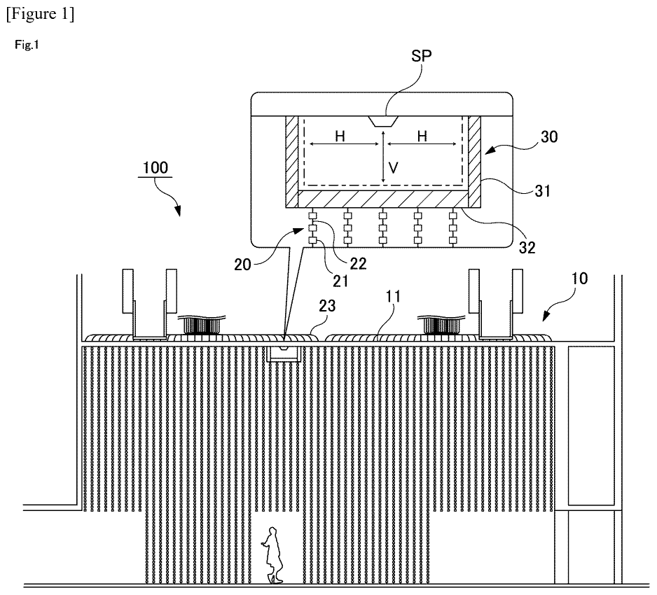

FIG. 1 illustrates a suspension structure 100 for a light-emitting device 20 according to one embodiment of the present invention. In the embodiment illustrated in FIG. 1, it is assumed that the multiple light-emitting devices 20 are installed in a windowless exhibition room in which a floor surface, a ceiling surface, and wall surfaces are each covered with mirrors. The light-emitting device 20 in which a plurality of light-emitting elements 21, such as LEDs, are coupled up and down by couplings 22 is employed, and the multiple light-emitting devices 20 are suspended from a ceiling 10 in the exhibition room. Cables 23 that supply electric power and control signals to these light-emitting devices 20 are provided on a back side of the ceiling 10. Some of the light-emitting devices 20 have a length that reaches the floor surface from the ceiling 10, and the others have a length that reaches only up to the proximity of the head of a spectator from the ceiling 10. By adjusting the length of the light-emitting device 20, a path for the spectator can be formed in the exhibition room. Such a light-emitting device 20 has been already publicly known as described also in the above-described NPL1.

As illustrated in FIG. 1, on a front side (indoor-side) of the ceiling 10 of the exhibition room, a sprinkler head SP is installed. While the installation standards of the sprinkler head SP are various, as in the exhibition room of the embodiment illustrated in FIG. 1, when the spectators are attracted in the windowless exhibition room and the multiple light-emitting devices 20 are installed, it is required to install the sprinkler on the ceiling 10 for fire prevention and spectator safety. At the peripheral of the sprinkler head SP, a “clearance zone” in which it is prohibited by the installation standards to place another object is provided not to obstruct sprinkling of water. In FIG. 1, this clearance zone is indicated by a one-dot chain line. As illustrated in FIG. 1, the clearance zone extends to a radius H in the horizontal direction with the sprinkler head SP as the center. That is, a diameter of the clearance zone is 2H. The clearance zone extends to a height V immediately below the sprinkler head SP in the vertical direction. Such a columnar range with the radius H and the height V is the clearance zone in which it is prohibited to place an object around the sprinkler head SP. While the standards of the radius H and the height V of the clearance zone are different depending on the country and the region, for example, generally, the radius H is from 20 to 50 cm and the height V is from 30 to 70 cm. More specifically, the radius H is 30 cm, and the height V is 45 cm. Thus, since it is prohibited to place another object in a certain range in the horizontal direction and the vertical direction of the sprinkler head SP, conventionally, the light-emitting device 20 and the like could not be installed below the sprinkler head SP.

The present invention mainly relates to a suspension unit 30 to enable installation of the light-emitting device 20 also below the sprinkler head SP. FIG. 1 schematically illustrates the suspension unit 30. As illustrated in FIG. 1, the suspension unit 30 is configured to allow the light-emitting device 20 to be suspended below the clearance zone while avoiding the above-described clearance zone around the sprinkler head SP. Specifically, the suspension unit 30 includes a plurality of hanging columns 31 fixed to the ceiling 10 and a support part 32 provided at lower portions of these hanging columns 31. These hanging columns 31 and the support part 32 are provided to surround the clearance zone around the sprinkler head SP, and any of them is not in the clearance zone. Therefore, even when the suspension unit 30 with this structure is arranged around the sprinkler head SP, it does not violate the installation standards. More specifically, a distance between the hanging columns 31 is equal to or more than the diameter 2H of the clearance zone, and the position of the support part 32 is apart from the head SP by equal to or more than the height V. Then, one or a plurality of light-emitting devices 20 can be suspended from the support part 32 of the suspension unit 30. Therefore, the light-emitting device 20 can be installed also below the clearance zone. As illustrated in the example of FIG. 1, since the sprinkler head SP and the suspension unit 30 are hidden behind the light-emitting device 20 from the spectator's eyes, the head SP and the suspension unit 30 are inconspicuous to the spectator.

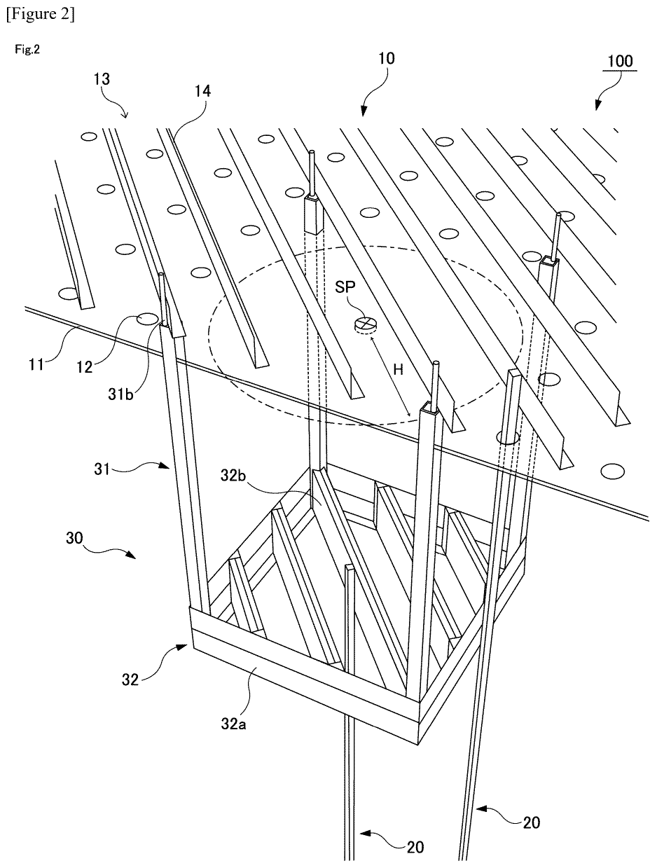

FIG. 2 illustrates a further specific configuration of the ceiling 10 and the suspension unit 30. FIG. 2 illustrates the simplified configuration of the light-emitting device 20. As illustrated in FIG. 2, the ceiling 10 includes a plate-shaped ceiling surface 11, and this ceiling surface 11 separates the room interior from the space above the ceiling in the exhibition room. The ceiling surface 11 is provided with holes 12 at predetermined intervals, and mainly the light-emitting devices 20 and the hanging columns 31 of the suspension unit 30 are inserted into the holes 12. On the back side of the ceiling surface 11 (the space above the ceiling), a supporting structure body 13 that supports the ceiling surface 11 and fixes the light-emitting device 20 and the suspension unit 30 is provided. In the example illustrated in FIG. 2, the supporting structure body 13 is configured by arranging a plurality of angle members 14 having L-shaped cross-sectional surfaces in parallel at approximately regular intervals. Bottom surfaces (horizontal surfaces) of the respective angle members 14 are fixed to the ceiling surface 11, and the angle members 14 have respective elevation surfaces (vertical surfaces) to which the light-emitting devices 20 and the hanging columns 31 of the suspension unit 30 can be fixed. A method for fixing the ceiling surface 11, the light-emitting devices 20, and the hanging columns 31 to the angle member 14 is not especially limited, and a known anchoring bracket may be used.

In the example illustrated in FIG. 2, the suspension unit 30 includes the four hanging columns 31. Each of the hanging columns 31 penetrates the ceiling surface 11 and is fixed to the supporting structure body 13 (the angle member 14) provided in the space above the ceiling. The number of the hanging columns 31 is preferably four or more but may be two or three.

In the suspension unit 30, at the lower ends of the respective hanging columns 31, the support part 32 capable of suspending the light-emitting device 20 is provided as described above. In the example illustrated in FIG. 2, the support part 32 includes a frame body 32a. This frame body 32a is configured with plate-shaped members bridged between the adjacent hanging columns 31 so as to surround all the hanging columns 31, and the inside of the frame body 32a is an opening portion. The support part 32 further includes a plurality of cross members 32b provided at the opening portion inside the frame body 32a. Each of the cross members 32b is fixed to the plate-shaped members constituting the frame body 32a so as to bridge the plate-shaped members. Specifically, in the example illustrated in FIG. 2, since the four hanging columns 31 are provided, the frame body 32a surrounding them makes a quadrilateral shape in plan view. With respect to the quadrilateral shape formed by the frame body 32a, each of the cross members 32b extends parallel to a diagonal direction. That is, the cross member 32b is basically obliquely bridged between the plate-shaped members corresponding to the adjacent sides of the quadrilateral shape formed by the frame body 32a. As illustrated in the example of FIG. 2, the cross member 32b may be bridged between the diagonal two hanging columns 31 among the hanging columns 31 provided at four corners of the quadrilateral shape. The cross members 32b are provided to be parallel to the diagonal direction of the quadrilateral-shaped frame body 32a and mutually spaced at predetermined intervals.

The cross member 32b of the suspension unit 30 has an elevation surface (vertical surface) approximately perpendicular to the ceiling surface 11 or the floor surface, and the light-emitting device 20 can be fixed to the elevation surface. A method for fixing the light-emitting device 20 to the cross member 32b is not especially limited, and similarly to the above-described angle member 14, a known anchoring bracket may be used. While FIG. 2 illustrates a state where one light-emitting device 20 is fixed to the cross member 32b of the suspension unit 30 as one example, a plurality of the light-emitting devices 20 can be fixed to the cross member 32b.

It is preferred that the extending direction of the cross member 32b of the suspension unit 30 be set to be approximately parallel to the extending direction of the angle member 14 in the space above the ceiling in plan view. This allows unifying the regularity to fix the light-emitting device 20 to the cross member 32b of the suspension unit 30 and the regularity to fix the light-emitting device 20 to the angle member 14 in the space above the ceiling, therefore; a sense of unity of the work as a whole is not impaired even at the position at which the light-emitting device 20 is fixed to the suspension unit 30.

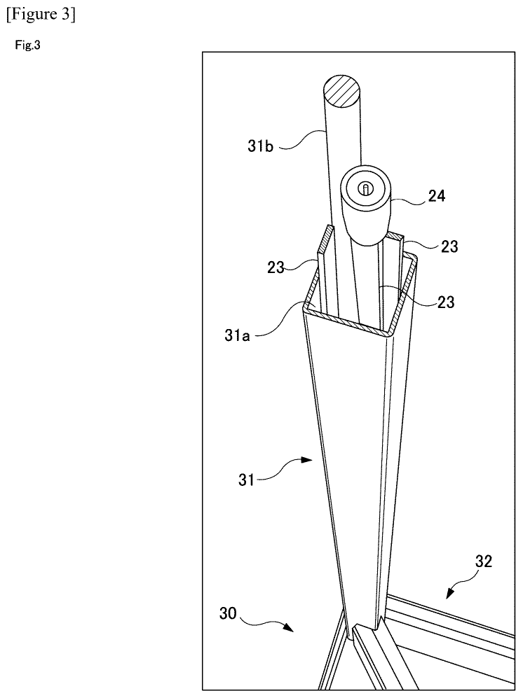

FIG. 3 schematically illustrates an internal structure of the hanging column 31 of the suspension unit 30. The hanging column 31 of the suspension unit 30 has a cylindrical shape (quadrilateral cylindrical shape) with a through-hole 31a penetrating in the up-and-down direction. A hanging bolt 31b is first inserted through the through-hole 31a of the hanging column 31. The hanging bolt 31b has a lower end portion screwed into a screw hole or the like (not illustrated) provided at the lower end of the hanging column 31 to be coupled, and the hanging column 31 has an upper end portion projecting upward with respect to the upper end of the hanging column 31. As illustrated in FIG. 2, the upper end portion of the hanging bolt 31b projecting from the hanging column 31 is fixed to the angle member 14 in the space above the ceiling by an anchoring bracket or the like.

The cable 23 connected to the light-emitting device 20 suspended from the suspension unit 30 can be inserted through the through-hole 31a of the hanging column 31. As illustrated in FIG. 3, while a connector 24 is usually coupled to an end portion of the cable 23, the through-hole 31a of the hanging column 31 has a space sufficient to cause the connector 24 to pass through. Therefore, by inserting the connector 24 into the hanging column 31 from the lower end of the through-hole 31a and extracting the connector 24 from the upper end of the through-hole 31a, the cable 23 can be housed inside the through-hole 31a. As illustrated in the example of FIG. 3, a plurality of the cables 23 can be housed in the through-hole 31a of the hanging column 31. Further, as illustrated in FIG. 2, since the upper end of the hanging column 31 reaches the space above the ceiling, the cable 23 can be guided to the space above the ceiling via the through-hole 31a of this hanging column 31. Therefore, by utilizing the through-hole 31a of the hanging column 31, it is possible to substantially prevent the cable 23 connected to the light-emitting device 20 from being visually perceived by the spectator in the exhibition room.

As described above, in the present specification, the embodiment of the present invention has been described with reference to the drawings in order to express the contents of the present invention. However, the present invention is not limited to the above-described embodiment but includes modifications and improvements obvious to those skilled in the art based on the matters described in the present specification.

### REFERENCE SIGNS LIST

10 . . . ceiling
11 . . . ceiling surface
12 . . . hole
13 . . . supporting structure body
14 . . . angle member
20 . . . light-emitting device
21 . . . light-emitting element
22 . . . coupling
23 . . . cable
24 . . . connector
30 . . . suspension unit
31 . . . hanging column
31a . . . through-hole
31b . . . hanging bolt
32 . . . support part
32a . . . frame body
32b . . . cross member
100 . . . suspension structure
SP . . . sprinkler head

1. A suspension unit (30) for suspending a light-emitting device (20) from a ceiling (10), comprising:
a plurality of hanging columns (31) fixed to the ceiling; and
a support part (32) provided at a lower portion of the plurality of hanging columns to support the light-emitting device, wherein
the suspension unit is configured such that all of the plurality of hanging columns are outside a clearance zone having a sprinkler head (SP) as a center in a horizontal direction specified in installation standards of the sprinkler head, and
the support part is provided at the lower portion of the hanging columns so as to be outside the clearance zone from the head in a vertical direction specified in the installation standards.

2. The suspension unit according to claim 1, wherein
the hanging column is formed in a cylindrical shape with a through-hole (31a) through which one or a plurality of cables connected to the light-emitting device are allowed to be inserted.

3. The suspension unit according to claim 2, wherein
a hanging bolt (31b) is further inserted through the through-hole of the hanging column, and
the hanging column is fixed to the ceiling using the hanging bolt.

4. The suspension unit according to claim 1, wherein
the support part includes:
a frame body (32a) fixed to the hanging columns; and
a plurality of cross members (32b) fixed to the frame body at intervals from each other, and
the light-emitting device is supported by the cross members.

5. A suspension structure (100) for suspending a light-emitting device (20) from a ceiling (10), comprising:
a ceiling surface (11);
a supporting structure body (13) provided on a back side of the ceiling surface;
a sprinkler head (SP) provided on a front side of the ceiling surface; and
a suspension unit (30) for suspending the light-emitting device below the sprinkler head, wherein
the suspension unit includes:
a plurality of hanging columns (31) fixed to the supporting structure body; and
a support part (32) provided at a lower portion of the plurality of hanging columns to support the light-emitting device,
the suspension unit is configured such that all of the plurality of hanging columns are outside a clearance zone having the sprinkler head (SP) as a center in a horizontal direction specified in installation standards of the sprinkler head, and
the support part is provided at the lower portion of the hanging columns so as to be outside the clearance zone from the head in a vertical direction specified in the installation standards.
